(19) United States
(12) Patent Application Publication
(10) Pub. No.: US 2012/0221209 A1
(43) Pub. Date: Aug. 30, 2012

(54) ACCELERATOR PEDAL ERRONEOUS OPERATION RESPONDING APPARATUS AND STORAGE MEDIUM

(75) Inventor: Junpei Tatsukawa, Chiryu-shi (JP)

(73) Assignee: DENSO CORPORATION, Kariya-city (JP)

(21) Appl. No.: 13/405,672

(22) Filed: Feb. 27, 2012

(30) Foreign Application Priority Data
Feb. 28, 2011 (JP) 2011-041852

(51) Int. Cl. B60W 30/00; B60W 10/20; B60W 10/184

(52) U.S. Cl. 701/42; 701/70

(57) ABSTRACT

An accelerator pedal erroneous operation responding apparatus for a vehicle is provided. The apparatus includes an erroneous operation determining unit which determines whether or not an accelerator pedal of the vehicle is erroneously operated when the accelerator pedal is operated, a deviation determining unit which determines whether or not the vehicle would deviate from a safe area when brake torque is generated for a left braking wheel and a right braking wheel of the vehicle at a current tire rudder angle of a wheel for steering of the vehicle, if the erroneous operation determining unit determines that the accelerator pedal is erroneously operated, and a brake torque generation controlling unit which generates brake torque for the right braking wheel or the left braking wheel, if the deviation determining unit determines that the vehicle would deviate from the safe area.

### CROSS-REFERENCE TO RELATED APPLICATION

This application is based on and claims the benefit of priority from earlier Japanese Patent Application No. 2011-41852 filed Feb. 28, 2011, the description of which is incorporated herein by reference.

### BACKGROUND

1. Technical Field

The present invention relates to an accelerator pedal erroneous operation responding apparatus and a storage medium.

2. Related Art

Conventionally, a technique is known which detects an operation in which an accelerator pedal is erroneously pressed (accelerator pedal erroneous operation), and generates brake torque for wheels based on the detection (refer to, e.g., JP-A-2006-123711).

When a driver erroneously operates the accelerator pedal, the driver is likely to be confused and not be able to appropriately operate the steering wheel. In such a case, even when braking force is generated for the wheels, the vehicle can deviate from a safe area, thereby entering a danger area.

### SUMMARY

An embodiment provides an accelerator pedal erroneous operation responding apparatus which detects an erroneous operation of an accelerator pedal, and generates brake force for wheels based on the detection. The apparatus reduces the possibility that a vehicle deviates from a safe area and enters a danger area even when the driver cannot appropriately operate the steering wheel.

As an aspect of the embodiment, an accelerator pedal erroneous operation responding apparatus for a vehicle is provided, the apparatus including: an erroneous operation determining unit which determines whether or not an accelerator pedal of the vehicle is erroneously operated when the accelerator pedal is operated; a deviation determining unit which determines whether or not the vehicle would deviate from a safe area when brake torque is generated for a left braking wheel and a right braking wheel of the vehicle at a current tire rudder angle of a wheel for steering of the vehicle, if the erroneous operation determining unit determines that the accelerator pedal is erroneously operated; and a brake torque generation controlling unit which generates brake torque for the right a braking wheel or the left braking wheel, if the deviation determining unit determines that the vehicle would deviate from the safe area.

### BRIEF DESCRIPTION OF THE DRAWINGS

In the accompanying drawings:

FIG. 1 is a block diagram showing a configuration of an in-vehicle system according to an embodiment of the present invention;

FIG. 2 is a flowchart of a process performed by an accelerator pedal erroneous operation responding apparatus;

FIG. 3 is a schematic view showing an example of behavior of a vehicle;

FIG. 4 is a view for explaining a criterion for determining whether the vehicle is deviated from a road; and

FIG. 5 is a view showing another scene to which the present invention is applied.

### DETAILED DESCRIPTION OF THE PREFERRED EMBODIMENTS

With reference to the accompanying drawings, hereinafter is described an embodiment of the present invention.

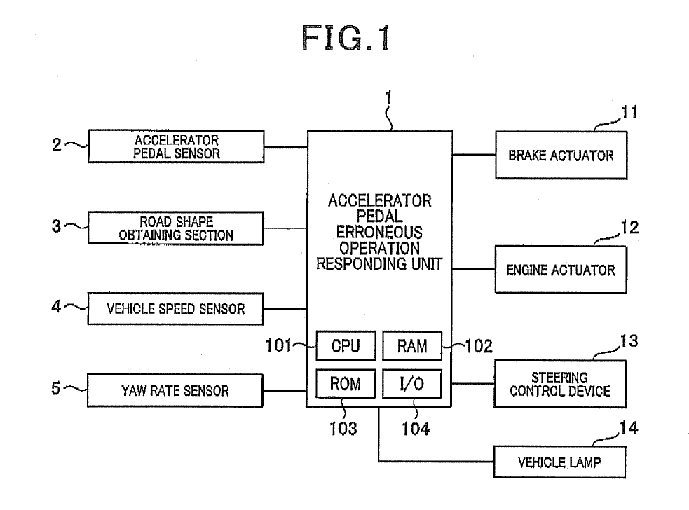

FIG. 1 is a block diagram showing a configuration of an in-vehicle system according to the embodiment. The in-vehicle system is installed in a vehicle, and has an accelerator pedal erroneous operation responding unit 1, an accelerator pedal sensor 2, a road shape obtaining section 3, a vehicle speed sensor 4, a yaw rate sensor 5, a brake actuator 11, an engine actuator 12, a steering control device 13, a vehicle lamp 14 and the like.

The accelerator pedal erroneous operation responding unit 1 (hereinafter, referred to as “erroneous operation responding unit 1”) detects an operation in which although a driver of the vehicle intends to press the brake pedal, the driver erroneously presses the accelerator pedal (accelerator pedal erroneous operation). The erroneous operation responding unit 1 generates braking force for the wheels based on the detection to stop the vehicle, thereby inhibiting the vehicle from starting. The erroneous operation responding unit 1 is realized by a microcomputer including a CPU 101, a RAM 102, a ROM 103, and an I/O 104. The CPU 101 of the erroneous operation responding unit 1 performs a process described later by executing a predetermined program stored in the ROM 103 (storage medium). That is, the program is computer readable.

The accelerator pedal sensor 2 detects the amount of operation of the accelerator pedal (e.g. accelerator opening, variation of accelerator opening) and outputs the amount of operation to the erroneous operation responding unit 1.

The road shape obtaining section 3 obtains information on the shape of a road existing in the direction of travel of the vehicle (forward direction when the vehicle is traveling forward, backward direction when the vehicle is traveling backward), for example, the road within 50 m from the own vehicle.

For example, the road shape obtaining section 3 may be an in-vehicle camera which takes images of the ground in the direction of travel of the vehicle or a map data storage medium storing information on shapes of roads around the country (e.g. position coordinates which are sequence of points aligned along road boundaries).

When the road shape obtaining section 3 is the in-vehicle camera as described above, the erroneous operation responding unit 1 detects a line of a road boundary (a white line, a line of a guardrail) or the like from an image of the ground taken by the in-vehicle camera, by using a known image-recognition technique. Based on the detected line, the erroneous operation responding unit 1 identifies the shape of the boundary of the road existing in the direction of travel of the vehicle and the radius of curvature of the road.

When the road shape obtaining section 3 is the map data storage medium as described above, the erroneous operation responding unit 1 identifies the shape of the boundary of the road existing in the direction of travel of the vehicle and the radius of curvature of the road based on the data of the map data storage medium.

The vehicle speed sensor 4 and the yaw rate sensor 5 are known sensors respectively detecting traveling speed and a yaw rate of the vehicle. In the present embodiment, the yaw rate, the moment, and the moment of inertia are the amounts centering on the center of gravity of the vehicle, when not stated elsewhere.

The brake actuator 11 is a braking mechanism of a service brake which generates braking force for the wheels of the vehicle, and includes a valve of a hydraulic braking mechanism, and a motor driving a hydraulic pump. The brake actuator 11 is normally controlled by a brake ECU (not shown) to meet a requirement for decelerating determined depending on the amount of pressing the brake pedal. However, when the accelerator pedal is erroneously pressed, the erroneous operation responding unit 1 controls the brake actuator 11, intervening in the control of the brake ECU in a superimposing manner (i.e. so as to add brake pressure).

Note that the wheels for which brake torque (axle torque) can be generated by the brake actuator 11 (i.e. braking wheels) may be only a right front wheel and a left front wheel, or only a right rear wheel and a left rear wheel. However, the brake torque generated for the left braking wheel and the brake torque generated for the right braking wheel can be independently controlled.

In addition, the braking wheels of the brake actuator 11 may be the right front wheel, the left front wheel, the right rear wheel and the left rear wheel. In this case, brake torque generated for each of the braking wheels can be independently controlled. Hereinafter, a case is described in which the braking wheels are the four wheels, that is, the right front wheel, the left front wheel, the right rear wheel and the left rear wheel.

The engine actuator 12 is a group of actuators controlling an engine which is a mechanism generating driving force for the vehicle, and includes a fuel injection device, a fuel ignition device, and a throttle valve opening/closing device. The engine actuator 12 is normally controlled by an engine ECU to meet a requirement for acceleration determined depending on accelerator opening. However, when the accelerator pedal is erroneously pressed, the erroneous operation responding unit 1 controls the engine actuator 12 to decrease the acceleration, intervening in the control of the engine ECU.

The steering control device 13 is an actuator which controls a steering wheel of the vehicle and the tire rudder angles of wheels for steering. In normal times, the steering wheel and the tire rudder angles of the wheels for steering are in synchronization with each other at a predetermined gear ratio (when the steering wheel is turned clockwise (to the right), the wheels for steering turn to the right). The steering control device 13 can change the gear ratio depending on the vehicle speed or the like.

In addition, the steering control device 13 includes a first motor controlling the tire rudder angles of wheels for steering and a second motor controlling the angle of the steering wheel. Output shafts of the first motor and the second motor are connected to each other by a link mechanism. When receiving an instruction concerning the tire rudder angles and the angle of the steering wheel from the erroneous operation responding unit 1, the steering control device 13 can control the first motor and the second motor to realize the tire rudder angles and the angle of the steering wheel according to the instruction.

As the above steering control device 13, for example, a known VGRS (Variable Gear Ratio Steering: registered trademark) can be used.

Note that, although only the right front wheel and the left front wheel are the wheels for steering in the present embodiment, other wheels may be wheels for steering as another embodiment.

The vehicle lamp 14 is a group of lamps, such as hazard lamps and brake lamps, for issuing notices to the outside of the vehicle, and can be controlled by the erroneous operation responding unit 1.

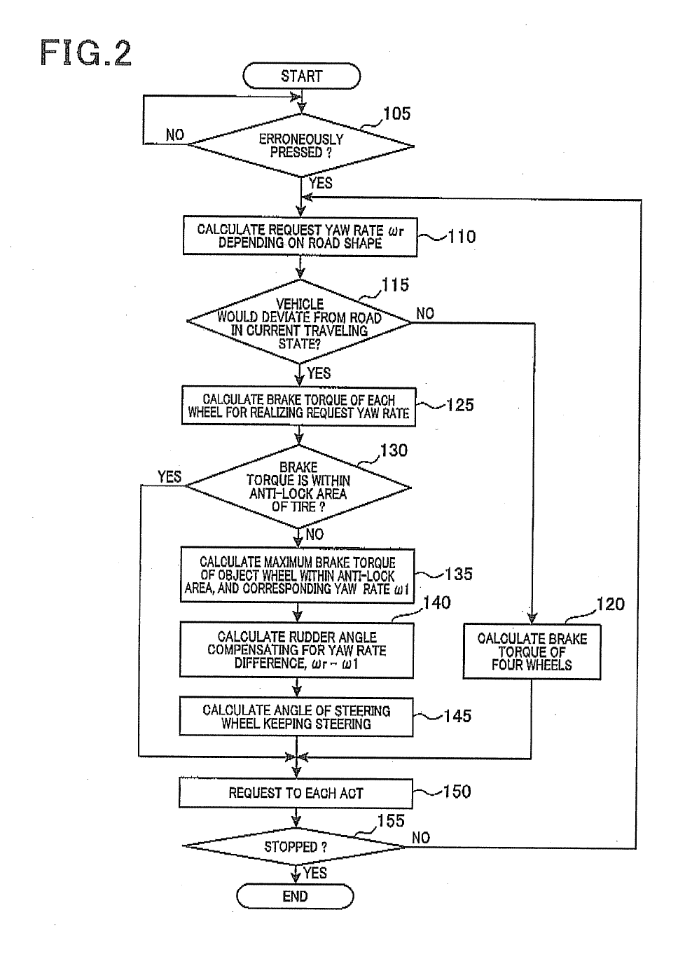

Hereinafter, an operation of the in-vehicle system will be described. When the erroneous operation responding unit 1 detects la the operation of the accelerator pedal by the driver based on a detection signal from the accelerator pedal sensor 2, the erroneous operation responding unit 1 starts executing the predetermined program to start the process shown in FIG. 2 according to the program.

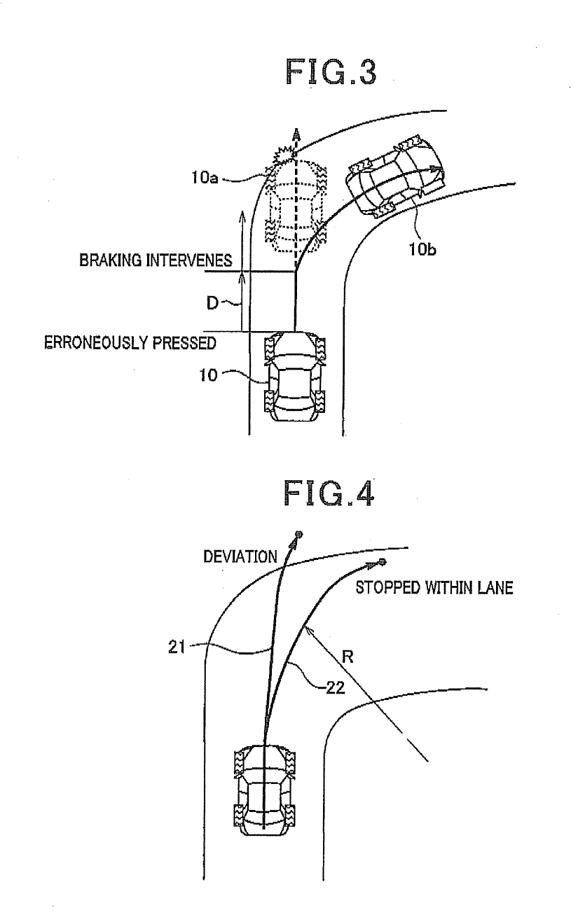

The process shown in FIG. 2 basically intervenes in braking and controls acceleration for the vehicle when the accelerator pedal is erroneously pressed, to stop the vehicle. In addition, the process is performed for ensuring the safety in such a scene as shown in FIG. 3.

As shown in FIG. 3, it is assumed that the accelerator pedal is erroneously operated when a vehicle 10, in which the erroneous operation responding unit 1 is installed, enters a curve. In such a case, a time lag is normally generated between the time when the accelerator pedal is erroneously operated and the time of the start of intervening in braking and the start of intervening in controlling for inhibiting the acceleration for the vehicle. As a result, a displacement D is caused between the point at which the accelerator pedal is erroneously pressed and the point at which intervening in braking and intervening in controlling for inhibiting the acceleration start. The displacement D is significant specifically in a down slope and a sharp curve. Even when intervening in braking and inhibiting the acceleration are caused in the vehicle 10 due to the above time lag, the displacement D caused by the time lag, braking distance for stopping the vehicle and the like, the vehicle 10 can travel as shown by the dashed line in FIG. 3. Hence, the vehicle 10 can deviate from the road at a position 10a depending on the shape of the road.

In this case, if the driver turns the steering wheel to the right (clockwise), the possibility that the vehicle deviates from the road becomes lower. However, since the driver is confused when erroneously operating the accelerator pedal, the driver would not be able to appropriately operate the steering wheel. In such a case, even when braking force is generated for the wheels, the vehicle can enter a danger area.

In the process shown in FIG. 2, to avoid such a situation as described above, when the accelerator pedal is erroneously operated short of a curve, braking force is generated only for the right braking wheel or the left braking wheel so that the vehicle does not deviate from the road.

For example, in the example shown in FIG. 3, braking force is generated only for the right brake to turn the vehicle 10 to the right as shown by a solid line so that the vehicle 10 is prevented from deviating from the road and stops at a position 10b.

Hereinafter, the process shown in FIG. 2 for realizing the above operation is described in detail. On starting the process shown in FIG. 2, in step 105, the erroneous operation responding unit 1 determines whether or not the accelerator pedal has erroneously been operated. For example, the erroneous operation responding unit 1 compares the variation of accelerator opening (i.e. the increasing amount of the accelerator opening per unit area) with a predetermined erroneous operation determination threshold value. If the variation of accelerator opening exceeds the erroneous operation determination threshold value, the erroneous operation responding unit 1 determines that the accelerator pedal has erroneously been operated. If the variation of accelerator opening does not exceed the erroneous operation determination threshold value, the erroneous operation responding unit 1 determines that the accelerator pedal has not been erroneously operated.

When the driver has intended to press the accelerator pedal and pressed the accelerator pedal, the variation of accelerator opening scarcely exceeds the erroneous operation determination threshold value. Hence, in this case, the erroneous operation responding unit 1 determines in step 105 that the accelerator pedal has not erroneously been operated, and performs the determination of S105 again.

When the driver has intended to press the brake pedal and erroneously pressed the accelerator pedal, the variation of accelerator opening often exceeds the erroneous operation determination threshold value because the brake pedal is often pressed more strongly than the accelerator pedal. Hereinafter, it is assumed that since the driver has intended to press the brake pedal and erroneously pressed the accelerator pedal, the erroneous operation responding unit 1 determines in step 105 that the accelerator pedal has erroneously been pressed.

Then, the process proceeds to step 110, and the erroneous operation responding unit 1 performs automatic braking control in step 110 or later. Specifically, the erroneous operation responding unit 1 performs intervention control for the brake actuator 11 to generate braking force. In addition, the erroneous operation responding unit 1 intervenes in the control of the engine actuator 12, which depends on the amount of pressing the accelerator pedal (accelerator opening), by the engine ECU to inhibit the vehicle from accelerating depending on the amount of pressing the accelerator pedal (e.g. totally closing the throttle valve). According to such intervention control, when the vehicle is traveling, the vehicle is stopped by the braking force while being inhibited from starting.

Hereinafter, the automatic braking control in step 110 or later is described in detail. First, in step 110, the erroneous operation responding unit 1 calculates a yaw rate depending on the shape of the road existing in the direction of travel of the vehicle (forward direction when the vehicle is traveling forward, backward direction when the vehicle is traveling backward), and sets the calculation result as a request yaw rate.

The request yaw rate depending on the shape of the road is a yaw rate required for the vehicle to travel in the road having the shape. The request yaw rate (or may be calculated, for example, by using an expression, ωr=V/Rr, where Rr is a radius of curvature (radius of a curve) of the road existing in the direction of travel of the vehicle and is obtained by the road shape obtaining section 3, and V is current vehicle speed of the vehicle obtained by the vehicle speed sensor 4.

Next, in step 115, if the driver has generated predetermined brake torque for the right and left braking wheels in a state where the driver cannot operate the steering wheel, the erroneous operation responding unit 1 determines whether or not the vehicle would deviate from the road (corresponding to a safe area).

Specifically, as shown in FIG. 4, paths 21, 22 in which the vehicle would travel are predicted by simulating time variations of the vehicle speed V and the yaw rate ω under the assumption that a current tire rudder angle δ of the wheel for steering (detected by a tire rudder angle sensor, which is not shown) does not vary, and that predetermined brake torque larger than zero is generated for each of the braking wheels, that is, the left front wheel, the left rear wheel, the right front wheel and the right rear wheel. Then, if the final point of the path 21, 22 (the point at which the speed V is zero) is within the area between the boundaries of the road existing in the direction of travel of the vehicle (i.e. road side) which are obtained by the road shape obtaining section 3, the erroneous operation responding unit 1 determines that “the vehicle would not deviate from the road.” If the final point of the path 21, 22 is not within the area between the boundaries of the road, the erroneous operation responding unit 1 determines that “the vehicle would deviate from the road.”

The predetermined brake torque of each of the braking wheels is set as brake torque which would be calculated in step 120. For example, each brake torque of all the braking wheels may be distributed so as to be the same. Alternatively, brake torque of the right front wheel and the left front wheel may be set to T1, and brake torque of the right rear wheel and the left rear wheel may be set to T2, where T1 differs from T2. In these cases, both the distribution ratio of the brake torque of the right front wheel and the left front wheel (corresponding to the first distribution ratio) and the distribution ratio of the brake torque of the right rear wheel and the left rear wheel (also corresponding to the first distribution ratio) are 1:1. Alternatively, brake torque of each of the braking wheels may be different from each other.

Each brake torque of the right front wheel and the left front wheel may be the same value larger than zero, and each brake torque of the left front wheel and the right rear wheel may be zero. In this case, both the distribution ratio of the brake torque of the right front wheel and the left front wheel (also corresponding to the first distribution ratio) and the distribution ratio of the brake torque of the left front wheel and the right rear wheel (also corresponding to the first distribution ratio) are 1:1.

Each brake torque of the left front wheel and the right front wheel may be the same value larger than zero, and each brake torque of the right front wheel and the left rear wheel may be zero. In this case, both the distribution ratio of the brake torque of the left front wheel and the right front wheel (also corresponding to the first distribution ratio) and the distribution ratio of the brake torque of the right front wheel and the left rear wheel (also corresponding to the first distribution ratio) are 1:1.

The simulation of the time variations of the vehicle speed V and the yaw rate ω is performed according to, for example, the following equations (1) and (2) of a known two wheels model, assuming that β corresponding to a slip angle is always zero.

$$\begin{matrix}mV \dot{β} + 2 ( {K}_{f} + {K}_{r} ) β + \{ mV + \frac{2}{V} ( {I}_{f} {K}_{f} - {I}_{r} {K}_{f} ) \} ω = 2 {K}_{f} δ & ( 1 ) \\ I \dot{ω} + 2 ( {I}_{f} {K}_{f} - {I}_{r} {K}_{r} ) β + \frac{2}{V} ( {I}_{f}^{2} {K}_{f} + {I}_{r}^{2} {K}_{r} ) ω - {M}_{BRK} = 2 {I}_{f} {K}_{f} δ & ( 2 )\end{matrix}$$

Note that Kf and Kr are cornering powers of the right and left front wheels and the right and left rear wheels, respectively. m and I are the mass and the moment of inertia of the vehicle, respectively. If and Ir are the distance between the center of gravity of the vehicle and the axle shaft of the front wheel and the distance between the center of gravity of the vehicle and the axle shaft of the rear wheel, respectively. Kf and Kr, m and I, and If and Ir are stored as predetermined values in the ROM 103 of the erroneous operation responding unit 1 or the like. In addition, M_{BRK} is the moment of the center of gravity of the vehicle (brake moment) generated by brake torque generated for the braking wheel.

In step 115, if the erroneous operation responding unit 1 determines that the vehicle would not deviate from the road, the process proceeds to step 120 in which the erroneous operation responding unit 1 calculates all the brake torque of the four wheels, that is, the right and left front wheels and the right and left rear wheels. In this case, the calculated brake torque is the same as the predetermined brake torque used in step 115. The process proceeds from step 120 to step 150 in which the erroneous operation responding unit 1 requests the brake torque of the four wheels calculated in step 120 to be applied by the brake actuator 11. Hence, the brake actuator 11 realizes the requested brake torque in each of the wheels. In this case, even when the tire rudder angle of the wheel for steering becomes 0° (i.e. when the vehicle travels in a straight line), the vehicle stops in the road with the very high possibility. Note that, in step 150, the erroneous operation responding unit 1 intervenes in control for inhibiting acceleration of the vehicle, such as totally closing the throttle valve, for the engine actuator 12.

Following step 150, in step 155, the erroneous operation responding unit 1 determines whether or not the vehicle has stopped based on the detection result of the vehicle sensor 4. If the vehicle has not stopped, the process returns to step 110. If the vehicle has stopped, the process shown in FIG. 2 is completed.

Therefore, while the erroneous operation responding unit 1 determines that the vehicle would not deviate from the road in step 115, the processes of steps 110, 115, 120, 150 and 155 are repeated until the vehicle stops. During the processes, brake torque is generated for the four wheels which are braking wheels.

Next, a case is described where the erroneous operation responding unit 1 determines that the vehicle would deviate from the road in step 115. In this case, the process proceeds to step 125 in which the erroneous operation responding unit 1 calculates brake torque of each of the braking wheels for realizing the request yaw rate cur calculated in step 110. The calculated brake torque of only one of the braking wheels (front wheel or rear wheel), which is positioned at the side to which the vehicle turns (right side when the vehicle turns right) according to the request yaw rate ωr, is larger than zero. The brake torque of other three braking wheels is zero.

For example, when the brake torque larger than zero is calculated for only the right front wheel, the distribution ratio of the brake torque of the right front wheel and the left front wheel (corresponding to the second distribution ratio) is 1:0, which differs from the distribution ratio in step 120. Hereinafter, the braking wheel for which the brake torque, which is not zero, is calculated is referred to as object braking wheel.

The brake torque of the object braking wheel is calculated as below. Correspondence maps are previously stored in the ROM 103 of the erroneous operation responding unit 1 for each combination of vehicle speed and a tire rudder angle of the wheel for steering. In the correspondence maps, the values of yaw rates, which are realized when brake torque is generated only for the object braking wheel, are associated with values of the brake torque. The brake torque realizing the value of the request yaw rate ωr is calculated by using the correspondence map corresponding to the current vehicle speed and tire rudder angle.

Next, in step 130, the erroneous operation responding unit 1 determines whether or not the brake torque of the object braking wheel calculated in step 125 is within an anti-lock area (the area in which the tire is not locked). Note that the anti-lock area is stored in the ROM 103 of the erroneous operation responding unit 1 as data previously determined for each current vehicle speed and tire rudder angle. When preparing the data, parameters of a coefficient of friction μ of the road surface, weight of the vehicle and the like are calculated as constant values.

If the erroneous operation responding unit 1 determines that the brake torque is within the anti-lock area, the tire would not be locked with very high possibility even when the brake torque of the object braking wheel calculated in step 125 is realized. Hence, the process proceeds to step 150 in which the erroneous operation responding unit 1 requests the brake torque of the object braking wheel calculated in step 125 to the brake actuator 11. Hence, the brake actuator 11 realizes the required brake torque for the object braking wheel and does not generate brake torque for the other braking wheels. Note that, in step 150, the erroneous operation responding unit 1 intervenes in control for inhibiting acceleration of the vehicle, such as totally closing the throttle valve, for the engine actuator 12.

Following step 150, in step 155, the erroneous operation responding unit 1 determines whether or not the vehicle has stopped based on the detection result of the vehicle sensor 4. If the vehicle has not stopped, the process returns to step 110. If the vehicle has stopped, the process shown in FIG. 2 is completed.

Therefore, while the erroneous operation responding unit 1 determines that the vehicle would deviate from the road in step 115 and determines that the brake torque is within the antilock area in step 130, the processes of steps 110, 115, 125, 130, 150 and 155 are repeated until the vehicle stops. During the processes, brake torque is generated only for the object braking wheel.

As described above, when the erroneous operation responding unit 1 detects an erroneous operation of the accelerator pedal, and if the erroneous operation responding unit 1 determines that the vehicle would deviate from the road (safe area) when brake torque is generated for the left braking wheel and the right braking wheel at the current tire rudder angle, the erroneous operation responding unit 1 generates brake torque only for the right braking wheel or only for the left braking wheel (the former in the example of FIG. 3). Hence, the vehicle takes a curve to the right side or left side (the former in the example of FIG. 3) with respect to the path which is generated when brake torque is equally generated for the right and left braking wheels in step 120. Hence, compared with the case where brake torque is generated for both the right and left braking wheels in step 120, the possibility is lowered that the vehicle deviates from the safe area and enters a danger area.

In addition, when the erroneous operation responding unit 1 detects an erroneous operation of the accelerator pedal, and if the erroneous operation responding unit 1 determines that the vehicle would deviate from the safe area when brake torque is generated for the left braking wheel and the right braking wheel by the first distribution ratio at the current tire rudder angle, the brake torque is generated for one or both of the right braking wheel and the left braking wheel of the vehicle by the second distribution ratio different from the first distribution ration. Hence, the vehicle takes a curve to the right side or the left side with respect to the path which is generated when brake torque is generated for both the right and left braking wheels by the first distribution ratio. Hence, compared with the case where brake torque is generated for both the right and left braking wheels by the first distribution ratio, the possibility is lowered that the vehicle deviates from the safe area and enters a danger area.

In addition, the erroneous operation responding unit 1 calculates the request yaw rate for traveling along the road shape in the direction of travel of the vehicle, and determines whether or not the request yaw rate can be realized without changing the tire rudder angle of the wheel for steering (step 130). Then, the erroneous operation responding unit 1 generates brake torque only for the object braking wheel based on the determination that the request yaw rate can be realized without changing the tire rudder angle of the wheel for steering, while keeping the tire rudder angle of the steering wheel, thereby realizing the request yaw rate.

Next, a case is described where it is determined, in step 130, that the brake torque of the object braking wheel is not within the anti-lock area (is outside the anti-lock area). In this case, when it is intended to realize the request yaw rate only by the brake torque, the tires are locked. Hence, the request yaw rate is realized by controlling both the brake torque and the tire rudder angles of the wheels for steering.

When it is determined that the brake torque of the object braking wheel is not within the anti-lock area, the process proceeds to step 135. In step 135, the erroneous operation responding unit 1 calculates a value of the yaw rate realized when the maximum brake torque of the object braking wheel is generated only for the object braking wheel within the anti-lock area while keeping the current tire rudder angle. The calculated yaw rate is set as yaw rate ω1. The yaw rate ω1 is obtained by identifying the yaw rate to be realized by the maximum brake torque by using the correspondence map corresponding to the current vehicle speed and tire rudder angle and included in the correspondence map described in step 125.

Next, in step 140, the tire rudder angle is calculated which compensates for the difference, ωr−ω1, between the request yaw rate ωr and the yaw rate ω1. This tire rudder angle can be calculated by using a linear relational expression of ω and δ expressed by the equation (1) of the two wheels model described above (however, where β is zero). The calculated tire rudder angle is included in an instruction sent to the steering control device 13.

Next, in step 145, the erroneous operation responding unit 1 obtains the current angle of the steering wheel (from a steering wheel angle sensor which is not shown). The erroneous operation responding unit 1 includes the angle of the steering wheel to be outputted to the steering control device 13 in the steering control device 13 to keep the obtained angle of the steering wheel.

Next, in step 150, the erroneous operation responding unit 1 requests the brake actuator 11 to generate the maximum brake torque of the object braking wheel within the anti-lock area calculated in step 135 as the brake torque of the object braking wheel. Hence, the brake actuator 11 realizes the requested brake torque for the object braking wheel and does not generate brake torque for the other braking wheels. Note that, in step 150, the erroneous operation responding unit 1 intervenes in control for inhibiting acceleration of the vehicle, such as totally closing the throttle valve, for the engine actuator 12.

Furthermore, in step 150, the erroneous operation responding unit 1 outputs an instruction, in which the tire rudder angle and the angle of the steering wheel are included in steps 140, 145, to the steering control device 13. The steering control device 13 controls the first motor and the second motor to realize the tire rudder angle and the angle of the steering wheel according to the instruction.

Following step 150, in step 155, the erroneous operation responding unit 1 determines whether or not the vehicle has stopped based on the detection result of the vehicle sensor 4. If the vehicle has not stopped, the process returns to step 110. If the vehicle has stopped, the process shown in FIG. 2 is completed.

Hence, while the erroneous operation responding unit 1 determines that the vehicle would deviate from the road in step 115 and determines that the brake torque of the object braking wheel is outside the anti-lock area in step 130, the processes of steps 110, 115, 125, 130, 135, 140, 145, 150 and 155 are repeated until the vehicle stops. During the processes, brake torque is generated only for the object braking wheel. The wheels for steering are turned in the direction of the curve, thereby meeting the request yaw rate.

In addition, in this state, the steering wheel is kept at the current angle. In the case where the accelerator pedal is erroneously operated, the driver can be confused, which stiffens the arms of the driver. Thereby, the steering wheel can be fixed. In such a case, if the erroneous operation responding unit 1 attempts to change the tire rudder angle and, in synchronization with the change of the tire rudder angle, to also turn the steering wheel, a force is exerted on hands of the driver. As a result, since the steering wheel automatically rotates with respect to the stiffened arms, the driver can be injured. To solve this problem, as described above, the angle of the steering wheel is kept without synchronizing the steering wheel with the change of the tire rudder angle, which can eliminate the factor by which the driver is further confused.

As described above, when the erroneous operation responding unit 1 detects an erroneous operation of the accelerator pedal, and if the erroneous operation responding unit 1 determines that the vehicle would deviate from the road (safe area) when brake torque is generated for the left braking wheel and the right braking wheel at the current tire rudder angle, the erroneous operation responding unit 1 generates brake torque only for the right braking wheel or only for the left braking wheel (the former in the example of FIG. 3). Hence, the vehicle takes a curve to the right side or the left side (the former in the example of FIG. 3) with respect to the path which is generated when brake torque is equally generated for the right and left braking wheels in step 120. Hence, compared with the case where brake torque is generated for both the right and left braking wheels in step 120, the possibility is lowered that the vehicle deviates from the safe area and enters a danger area.

In addition, when the erroneous operation responding unit 1 detects an erroneous operation of the accelerator pedal, and if the erroneous operation responding unit 1 determines that the vehicle would deviate from the safe area when brake torque is generated for the left braking wheel and the right braking wheel by the first distribution ratio at the current tire rudder angle, the brake torque is generated for one or both of the right braking wheel and the left braking wheel of the vehicle by the second distribution ratio different from the first distribution ration. Hence, the vehicle takes a curve to the right side or left side with respect to the path which is generated when brake torque is generated for both the right and left braking wheels by the first distribution ratio. Hence, compared with the case where brake torque is generated for both the right and left braking wheels by the first distribution ratio, the possibility is lowered that the vehicle deviates from the safe area and enters a danger area.

In addition, the erroneous operation responding unit 1 calculates the request yaw rate for traveling along the road shape in the direction of travel of the vehicle, and determines whether or not the request yaw rate can be realized without changing the tire rudder angle of the wheels for steering (step 130). Then, the erroneous operation responding unit 1 generates brake torque only for the object braking wheel based on the determination that the request yaw rate cannot be realized without changing the tire rudder angle of the wheels for steering, and changes the tire rudder angle of the wheels for steering, thereby performing the control meeting the request yaw rate. As described above, when the request yaw rate cannot be realized by the brake torque without changing the tire rudder angle, the tire rudder angle is automatically changed regardless of the steering by the driver. Hence, even in a condition in which the driver cannot appropriately perform steering, the possibility can further be lowered that the vehicle enters a danger area.

The erroneous operation responding unit 1 may light up hazard lamps or brake lamps of the vehicle lamp 14 (e.g. blinking at short intervals) immediately after determining that the accelerator pedal is erroneously operated in step 105 and before step 150, to indicates to the following vehicle that the own vehicle will turn and suddenly brake. Alternatively, the erroneous operation responding unit 1 may light up the hazard lamps or brake lamps of the vehicle lamp 14 (e.g. blinking at short intervals) immediately after determining that the vehicle would deviate from the safe area in step 115 and before step 150.

As described above, by issuing an alarm to the periphery of the own vehicle based on the determination that the accelerator pedal is erroneously operated or the determination that the vehicle would deviate from the safe area, drivers of other vehicles around the own vehicle can sense the abnormality of the own vehicle more quickly.

It will be appreciated that the present invention is not limited to the configurations described above, but any and all modifications, variations or equivalents, which may occur to those who are skilled in the art, should be considered to fall within the scope of the present invention.

### Other Embodiments

(1) In the above embodiment, the erroneous operation responding unit 1 calculates a request yaw rate depending on the road shape in step 110. If determining that the vehicle would deviate from the road in step 115, the accelerator pedal erroneous operation responding unit 1 generates brake torque so as to realize the request yaw rate, and changes the tire rudder angle if needed.

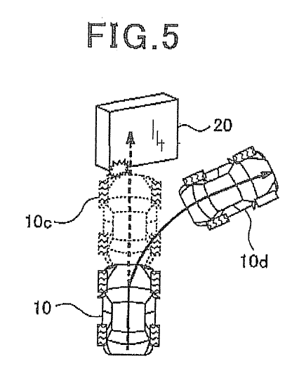

However, the brake torque might not necessarily realize the request yaw rate depending on the road shape. For example, as shown in FIG. 5, the vehicle 10, in which the erroneous operation responding unit 1 is installed, includes obstacle sensor (e.g. sonar sensor, laser sensor) which senses obstacles outside the vehicle. It is assumed that when the accelerator pedal has been erroneously operated, the obstacle sensor has detected an obstacle 20 existing in the direction of travel of the vehicle. In this case, if the erroneous operation responding unit 1 determines that the accelerator pedal has been erroneously operated in the same process as that of step 105, the process bypasses step 110, then the erroneous operation so responding unit 1 determines whether or not the vehicle deviates from the safe area by the process equivalent to that of step 115. Note that, in this case, the safe area corresponds to an area outside the area in which the obstacle 20 exists. If the erroneous operation responding unit 1 determines that the vehicle would deviate from the safe area (i.e. the vehicle would strike the obstacle as shown by 10c), braking force is generated only for the predetermined object braking wheel (e.g. right front wheel). Hence, the path of the vehicle 10 is curved as indicated by a solid line, thereby deviating the vehicle 10 from the obstacle 20 as indicated by 10d. The above configuration also achieves an object of the present invention.

(2) In the above embodiment, the object braking wheel is only the right front wheel when the vehicle turns to the right depending on the request yaw rate, or only the left front wheel when the vehicle turns to the left depending on the request yaw rate. However, the object braking wheel may be only the right rear wheel when the vehicle turns to the right, or only the left rear wheel when the vehicle turns to the left. Alternatively, the object braking wheel may be only the right front and rear wheels when the vehicle turns to the right, or only the left front and rear wheels when the vehicle turns to the left. Note that the request yaw rate can be realized more easily when one of the front and rear wheels is the object braking wheel than when both the front and rear wheels are the object braking wheels.

(3) In the above embodiment, even when the tire rudder angle is changed in steps 140, 145, and 150, the angle of the steering wheel is controlled so as to be kept. However, instead of keeping the angle of the steering wheel, the connection between the tire rudder angle and the steering wheel may be released not to control the angle of the steering wheel regardless of the tire rudder angle. Thereby, the steering wheel is allowed to move in response to the operation by the driver. That is, in steps 140, 145, and 150, the angle of the steering wheel may not synchronize with the tire rudder angle.

(4) In the above embodiment, the distribution ratio of the brake torque of the right front wheel and the left front wheel (corresponding to the first distribution ratio) and the distribution ratio of the brake torque of the right rear wheel and the left rear wheel (also corresponding to the first distribution ratio) in step 120 may not be the same. In practice, control may be performed so that the distribution ratio of the brake torque of the right and left braking wheels varies depending of the curve of the road existing in the direction of travel of the vehicle. Also in this case, if the first distribution ratio differs from the distribution ratio of the brake torque of the right front wheel and the left front wheel (corresponding to the second distribution ratio) in step 125, that is, if the torque distribution of the braking wheel on the side to which the vehicle turns depending on the request yaw rate is larger than that of the other braking wheel, compared with the first distribution ratio, an object of the present invention can be achieved.

(5) In the above embodiment, only the brake actuator 11 of the service brake is used to generate brake torque for the braking wheel. However, the brake torque may be generated for the braking wheel by mainly using a regeneration brake mechanism (which generates brake torque for a braking wheel and charges a battery by using the brake torque). In this case, only when the required brake torque is not satisfied, the shortage may be satisfied by generating brake torque by the service brake. Note that, in the above embodiment, since the brake torque may be generated only for the object braking wheel, the regeneration brake mechanism is provided for each of the braking wheels.

In addition, in the above embodiment, the functions realized by executing the program by the erroneous operation responding unit 1 may be realized using hardware having the functions (e.g. FPGA in which circuit configurations are programmable).

Hereinafter, aspects of the above-described embodiments will be summarized.

As an aspect of the embodiment, an accelerator pedal erroneous operation responding apparatus for a vehicle is provided, the apparatus including: an erroneous operation determining unit (105) which determines whether or not an accelerator pedal of the vehicle is erroneously operated when the accelerator pedal is operated; a deviation determining unit (115) which determines whether or not the vehicle would deviate from a safe area when brake torque is generated for a left braking wheel and a right braking wheel of the vehicle at a current tire rudder angle of a wheel for steering of the vehicle, if the erroneous operation determining unit (110) determines that the accelerator pedal is erroneously operated; and a brake torque generation controlling unit (120, 135-150) which generates brake torque for the right braking wheel or the left braking wheel, if the deviation determining unit (115) determines that the vehicle would deviate from the safe area.

As described above, when the erroneous operation responding unit detects an erroneous operation of the accelerator pedal, and if the erroneous operation responding unit determines that the vehicle would deviate from the safe area when brake torque is generated for the left braking wheel and the right braking wheel at the current tire rudder angle, the erroneous operation responding unit generates brake torque only for the right braking wheel or only for the left braking wheel. Hence, the vehicle takes a curve to the right side or left side with respect to the path which is generated when brake torque is equally generated for the right and left braking wheels. Hence, compared with the case where brake torque is generated for both the right and left braking wheels, the possibility is lowered that the vehicle deviates from the safe area and enters a danger area.

The apparatus further includes: a request yaw rate calculating unit (110) which calculates a request yaw rate depending a shape of a road existing in the direction of travel of the vehicle; and a request yaw rate realization determining unit (130) which determines whether or not the request yaw rate is realized without changing the tire rudder angle of the wheel for steering. If the deviation determining unit (115) determines that the vehicle would deviate from the safe area and the request yaw rate realization determining unit (130) determines that the request yaw rate is not realized without changing the tire rudder angle of the wheel for steering, the brake torque generation controlling unit (120, 135-150) generates brake torque for the right braking wheel or the left braking wheel and changes the tire rudder angle of the wheel for steering, to meet the request yaw rate.

As described above, when the request yaw rate cannot be realized by the brake torque without changing the tire rudder angle, the tire rudder angle is automatically changed regardless of the steering by the driver. Hence, even in a condition in which the driver cannot appropriately perform steering, the possibility can further be lowered that the vehicle enters a danger area.

In the apparatus, when the brake torque generation controlling unit (120, 135-150) generates brake torque for the right braking wheel or the left braking wheel and changes the tire rudder angle of the wheel for steering, a steering wheel of the vehicle is not synchronized with the change of the tire rudder angle.

In the case where the accelerator pedal is erroneously operated, the driver can be confused, which stiffens the arms of the driver. Thereby, the steering wheel can be fixed. In such a case, if the erroneous operation responding unit attempts to change the tire rudder angle and, in synchronization with the change of the tire rudder angle, to also turn the steering wheel, a force is exerted on hands of the driver. As a result, since the steering wheel automatically rotates with respect to the stiffened arms, the driver can be injured. To solve this problem, as described above, the angle of the steering wheel is kept without synchronizing the steering wheel with the change of the tire rudder angle, which can eliminate the factor by which the driver is further confused.

The apparatus further includes an alarm unit which issues an alarm to the periphery of the vehicle when the erroneous operation determining unit (105) determines that the accelerator pedal is erroneously operated. According to this configuration, drivers of other vehicles around the vehicle can sense the abnormality of the vehicle more quickly.

As another aspect of the embodiment, an accelerator pedal erroneous operation responding apparatus for a vehicle is provided, the apparatus including: an erroneous operation determining unit (105) which determines whether or not an accelerator pedal of the vehicle is erroneously operated when the accelerator pedal is operated; a deviation determining unit (115) which determines whether or not the vehicle would deviate from a safe area when brake torque is generated for a left braking wheel and a right braking wheel of the vehicle by a first distribution ratio at a current tire rudder angle of a wheel for steering of the vehicle, if the erroneous operation determining unit (110) determines that the accelerator pedal is erroneously operated; and a brake torque generation controlling unit (120, 135-150) which generates brake torque for the right braking wheel and the left braking wheel by the first distribution ratio, if the deviation determining unit (115) determines that the vehicle would not deviate from the safe area, and generates brake torque for at least one of the right braking wheel and the left braking wheel by a second distribution ratio, if the deviation determining unit (115) determines that the vehicle would deviate from the safe area.

As described above, when the erroneous operation responding unit detects an erroneous operation of the accelerator pedal, and if the erroneous operation responding unit determines that the vehicle would deviate from the safe area when brake torque is generated for the left braking wheel and the right braking wheel at the current tire rudder angle, the erroneous operation responding unit generates brake torque for at least one of the right braking wheel and the left braking wheel. Hence, the vehicle takes a curve to the right side or the left side with respect to the path which is generated when brake torque is generated for both the right and left braking wheels. Hence, compared with the case where brake torque is generated for both the right and left braking wheels, the possibility is lowered that the vehicle deviates from the safe area and enters a danger area.

As another aspect of the embodiment, a storage medium is provided which stores a computer readable program used for the accelerator pedal erroneous operation responding apparatus for a vehicle.

What is claimed is:

1. An accelerator pedal erroneous operation responding apparatus for a vehicle, comprising:
an erroneous operation determining unit which determines whether or not an accelerator pedal of the vehicle is erroneously operated when the accelerator pedal is operated;
a deviation determining unit which determines whether or not the vehicle would deviate from a safe area when brake torque is generated for a left braking wheel and a right braking wheel of the vehicle at a current tire rudder angle of a wheel for steering of the vehicle, if the erroneous operation determining unit determines that the accelerator pedal is erroneously operated; and
a brake torque generation controlling unit which generates brake torque for the right braking wheel or the left braking wheel, if the deviation determining unit determines that the vehicle would deviate from the safe area.

2. The accelerator pedal erroneous operation responding apparatus according to claim 1, further comprising:
a request yaw rate calculating unit which calculates a request yaw rate depending a shape of a road existing in the direction of travel of the vehicle; and
a request yaw rate realization determining unit which determines whether or not the request yaw rate is realized without changing the tire rudder angle of the wheel for steering, wherein
if the deviation determining unit determines that the vehicle would deviate from the safe area and the request yaw rate realization determining unit determines that the request yaw rate is not realized without changing the tire rudder angle of the wheel for steering, the brake torque generation controlling unit generates brake torque for the right braking wheel or the left braking wheel and changes the tire rudder angle of the wheel for steering, to meet the request yaw rate.

3. The accelerator pedal erroneous operation responding apparatus according to claim 2, wherein
when the brake torque generation controlling unit generates brake torque for the right braking wheel or the left braking wheel and changes the tire rudder angle of the wheel for steering, a steering wheel of the vehicle is not synchronized with the change of the tire rudder angle.

4. The accelerator pedal erroneous operation responding apparatus according to claim 1, further comprising an alarm unit which issues an alarm to the periphery of the vehicle when the erroneous operation determining unit determines that the accelerator pedal is erroneously operated.

5. An accelerator pedal erroneous operation responding apparatus for a vehicle, comprising:
an erroneous operation determining unit which determines whether or not an accelerator pedal of the vehicle is erroneously operated when the accelerator pedal is operated;
a deviation determining unit which determines whether or not the vehicle would deviate from a safe area when brake torque is generated for a left braking wheel and a right braking wheel of the vehicle by a first distribution ratio at a current tire rudder angle of a wheel for steering of the vehicle, if the erroneous operation determining unit determines that the accelerator pedal is erroneously operated; and
a brake torque generation controlling unit which generates brake torque for the right braking wheel and the left braking wheel by the first distribution ratio, if the deviation determining unit determines that the vehicle would not deviate from the safe area, and generates brake torque for at least one of the right braking wheel and the left braking wheel by a second distribution ratio, if the deviation determining unit determines that the vehicle would deviate from the safe area.

6. A storage medium which stores a computer readable program used for an accelerator pedal erroneous operation responding apparatus for a vehicle, the program comprising:
determining whether or not an accelerator pedal of the vehicle is erroneously operated when the accelerator pedal is operated;
determining whether or not the vehicle would deviate from a safe area when brake torque is generated for a left braking wheel and a right braking wheel of the vehicle at a current tire rudder angle of a wheel for steering of the vehicle, if it is determined that the accelerator pedal is erroneously operated; and
generating brake torque for the right braking wheel or the left braking wheel, if it is determined that the vehicle would deviate from the safe area.

7. A storage medium which stores a computer readable program used for an accelerator pedal erroneous operation responding apparatus for a vehicle, the program comprising:
determining whether or not an accelerator pedal of the vehicle is erroneously operated when the accelerator pedal is operated;
determining whether or not the vehicle would deviate from a safe area when brake torque is generated for a left braking wheel and a right braking wheel of the vehicle by a first distribution ratio at a current tire rudder angle of a wheel for steering of the vehicle, if it is determined that the accelerator pedal is erroneously operated; and
generating brake torque for the right braking wheel and the left braking wheel by the first distribution ratio, if it is determined that the vehicle would not deviate from the safe area, and generating brake torque for at least one of the right braking wheel and the left so braking wheel by a second distribution ratio, if it is determined that the vehicle would deviate from the safe area.
